(19) United States
(12) Patent Application Publication
(10) Pub. No.: US 2005/0067344 A1
(43) Pub. Date: Mar. 31, 2005

(54) Zeolite membrane support and zeolite composite membrane

(75) Inventors: Takeharu Tanaka, Kobe-shi (JP); Hiroyuki Mitani, Kobe-shi (JP); Koji Yamamoto, Kobe-shi (JP); Keita Yura, Kobe-shi (JP); Toshiki Sato, Kobe-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd.), Kobe-shi (JP)

(21) Appl. No.: 10/950,448

(22) Filed: Sep. 28, 2004

(30) Foreign Application Priority Data
Sep. 30, 2003 (JP) 2003-339914

(51) Int. Cl. B01D 39/20

(52) U.S. Cl. 210/490; 210/503; 210/504; 210/506; 210/509

(57) ABSTRACT

A zeolite membrane support for supporting a zeolite membrane includes a metal substrate having a metal oxide layer at its surface. Preferably, the metal oxide layer has a thickness in the range of 1 nm to 10 μm and comprises chromia, silica, or alumina. Preferably, the metal substrate is porous, having a mean pore size in the range of 10 nm to 50 μm, and comprises an iron-based metal. A zeolite composite membrane includes the zeolite membrane support and a zeolite membrane which includes an external zeolite layer lying over the surface at and/or an internal zeolite layer lying in the pores at the metal oxide layer side of the zeolite membrane support. The zeolite membrane preferably has a composition satisfying the relationship SiO₂/Al₂O₃≦10.

### BACKGROUND OF THE INVENTION

1. Field of the Invention

The present invention relates to a zeolite membrane support and a zeolite composite membrane.

2. Description of the Related Art

Zeolite membranes have pores of several angstroms in their crystals, and are expected to be used as separation membranes, membrane reactors, and the like for molecular sieve gas separation, pervaporation, and other applications using the pores of the zeolite membrane. However, the zeolite membranes themselves do not have sufficient mechanical strength and are difficult to use alone. Accordingly, the zeolite membranes generally supported by porous supports.

Zeolites for such a zeolite membrane include silicalite, ZSM-5, faujasite, zeolite A, and mordenite, and these zeolites can be used in various separation processes. For the synthesis of the zeolite membrane, some processes have been proposed, including a process by sol or gel hydrothermal treatment.

In general, zeolite is synthesized on a porous alumina support to form the zeolite membrane. However, since porous alumina is brittle and easily broken, it is difficult to handle. In addition, no joining technique has been developed for a modularized or upsized zeolite membrane.

The zeolite membrane is generally formed in an alkaline sol or gel. Unfortunately, alumina leaches into the sol or gel from the support at this point. Consequently, a zeolite having a desired composition cannot be obtained, the crystal system of the zeolite may be changed, or the formation of the zeolite membrane may be negatively affected.

The support may be formed of zirconium oxide, titanium oxide, tantalum oxide, niobium oxide, or the like instead of alumina, as disclosed in Japanese Unexamined Patent Application Publication No. 11-137981. While these materials do not leach into the sol or gel, they have not yet adapted to the upsizing of the support nor led to an effective joining technique or other advantageous techniques.

Stainless supports have also been disclosed for synthesizing zeolite membranes in, for example, Eduard R. Geus et al., Microporous Materials, 1 (1993), 131-147 and Yamazaki et al., Microporous Materials, 5 (1995), 245-253. However, in these documents, the stainless supports are used for only high-silica zeolites, such as MFI zeolites and high-silica mordenite. In Guillaume Clet et al., Chem. Commun., (2001), 41-42, zeolite Y is synthesized on a special stainless support called Trumem™, which has a two-layer structure including a titania layer at the surface. However, this type of stainless is not easily available, disadvantageously.

In general, the surfaces of metals, especially of stainless alloy, have low affinity (wettability) for zeolite synthesis sol or gel. Accordingly, it is difficult to form a satisfactory zeolite membrane on the surface of such a metal, except for high-silica zeolite membranes.

### SUMMARY OF THE INVENTION

Accordingly, objects of the present invention are to provide a support on which a zeolite membrane can be satisfactorily formed even if the zeolite membrane comprises a material other than high-silica zeolite, and to provide a zeolite composite membrane.

The inventors of the present invention have conducted intensive research to accomplish the objects and complete the invention.

The present invention provides a zeolite membrane support and a zeolite composite membrane.

According to an aspect of the present invention, a zeolite membrane support is provided for supporting a zeolite membrane. The support comprises a metal substrate having a metal oxide layer at its surface.

Preferably, the metal oxide layer has a thickness in the range of 1 nm to 10 μm.

Preferably, the metal substrate is porous.

Preferably, the metal substrate has a mean pore size in the range of 10 nm to 50 μm.

Preferably, the metal substrate comprises an iron-based metal.

Preferably, the metal oxide layer comprises an oxide selected from the group consisting of chromia, silica, and alumina.

According to another aspect of the present invention, a zeolite composite membrane is provided which includes an external zeolite layer lying over the surface at and/or an internal zeolite layer lying in the pores at the metal oxide layer side of the zeolite membrane support.

Preferably, the internal zeolite layer has a thickness in the range of 0.1 to 200 μm.

Preferably, the zeolite membrane has a composition satisfying the relationship SiO₂/Al₂O₃≦10.

Preferably, the zeolite membrane comprises a zeolite selected from the group consisting of zeolite X, zeolite Y, and zeolite A.

By using the zeolite membrane support of the present invention, even zeolite other than high-silica zeolite can be formed into a satisfactory membrane. The zeolite composite membrane of the present invention has a satisfactorily formed zeolite membrane.

### BRIEF DESCRIPTION OF THE DRAWINGS

FIG. 1 is a schematic illustration of an arrangement for a gas separation test performed on a zeolite composite membrane prepared in an example according to the present invention; and

FIG. 2 is a schematic illustration of a zeolite composite membrane, showing the thicknesses of zeolite layers formed outside and inside a support.

### DESCRIPTION OF THE PREFERRED EMBODIMENTS

In general, it is difficult to satisfactorily deposit zeolite other than high-silica zeolite on the untreated surface of a metal, especially stainless alloy.

In view of such circumstances, the inventors of the present invention have conducted intensive research. As a result, the inventors have made it possible to easily deposit even zeolite other than high-silica zeolite on a metal surface, by providing a metal oxide layer, such as of chromia, silica, alumina, titania, or zirconia, at the surface of the metal by surface oxidation or a sol-gel method to enhance the affinity for the zeolite synthesis sol or gel of the metal surface and thus to facilitate nucleation of zeolite crystals (or to provide a nucleation site).

A zeolite membrane support for supporting a zeolite membrane of the present invention comprises a metal substrate having a metal oxide layer at its surface. The metal oxide layer at the surface of the zeolite membrane support facilitates the deposition of even zeolite other than high-silica zeolite.

Since the zeolite membrane support has the metal oxide layer at the surface of the metal substrate, the support is hard to break. In addition, since constituents of the support do not easily leach into the sol or gel during the synthesis of zeolite, the resulting zeolite membrane can be ensured to have a desired composition and the crystal system of the zeolite is not easily changed. Thus, the support of the present invention facilitates the formation of the zeolite membrane. Moreover, the support can provide a joining technique required for modularization or upsizing.

The zeolite membrane support, which is a metal substrate having a metal oxide layer at the surface, is, in other words, constituted of a metal having a metal oxide layer on its surface. In view of use as substrates, metals often have high oxidation resistance and other environmental resistance, suitable properties for joining parts, and durability in operation of equipment, and are thus suitable for modularization and upsizing. The metal substrate may be formed of a nonferrous metal, such as titanium, nickel, or aluminium, or their alloy. However, iron-based metals, particularly stainless steel, are preferable from a comprehensive viewpoint, including heat resistance, oxidation resistance, structural strength, and cost.

The zeolite membrane support is formed in any shape without particular limitation, and may be in a form of, for example, plate, tube, sphere, monolith, or honeycomb.

If the zeolite membrane is used for separation, that is, if the zeolite membrane support of the present invention is used as the support of a zeolite membrane for separation, the metal substrate of the support is porous.

Preferably, the support of the zeolite membrane using for separation has a low permeation resistance or a high gas permeability. Accordingly, it is preferable that the zeolite membrane support has a two-layer or more multilayer structure including a finely porous layer at the zeolite membrane-forming side and a coarser layer having a lower permeation resistance under the finely porous layer.

Although the metal substrate for the separation membrane is porous, an excessively large pore size undesirably causes defects in the zeolite membrane and degrades the separation properties. Therefore, the mean pore size of the porous metal is preferably 50 μm or less, more preferably 10 μm or less, still more preferably 1 μm or less, and particularly 0.1 μm or less. The lower limit of the mean pore size of the porous metal is set depending on what is separated, but preferably 10 nm from the viewpoint of permeation rate. The pore size can be determined by mercury porosimetry using a high surface tension of mercury, in which mercury is pressurized to be injected into pores and pore size distribution is obtained from the pressure and the amount of the mercury injected into the pores. Specifically, the pore size is expressed by average pore size distribution obtained by the mercury porosimetry.

The metal oxide layer at the surface of the metal substrate is formed of various metal oxides without particular limitation. Exemplary metal oxides include chromia, silica, and alumina.

The porous metal substrate is prepared, for example, in the following process. First, metal powder is formed into a desired shape by powder compaction, a CIP method, extrusion, or the like, optionally followed by drying. Then, the resulting compact is fired.

In extrusion, the metal powder is kneaded with a binder, such as cellulose, methylcellulose, or wax, and then formed into a tube with an extruder. In this instance, the tube may have a two-layer structure composed of a thin and finely porous outer layer and a coarse inner layer. The porous metal tube substrate is cut to an appropriate length, dried, and sintered. The sintering temperature is set depending on the type of metal. Stainless steel powder is generally sintered at a temperature of 800 to 1,000° C. in a non-oxidizing atmosphere after dewaxing at a temperature of 200 to 600° C.

The metal oxide layer is formed at the surface of the metal substrate by oxidation of the surface of the metal substrate or a sol-gel method.

For oxidation of the metal surface, the metal substrate may be heat-treated in such an atmosphere and temperature that only a specific constituent in the metal substrate is oxidized and that other constituents are reduced.

The combination of the metal of the metal substrate and the metal oxide of the metal oxide layer is not particularly limited. For example, an Fe—Cr alloy substrate is coated with a chromia layer; and Fe—Cr—Si alloy substrate, a chromia layer and a silica layer; an Fe—Si—Al alloy substrate, an alumina layer and a silica layer; and an Fe—Si alloy substrate, a silica layer.

In order to form a chromia layer at the surface of an Fe—Cr alloy substrate, conditions are selected from an Ellingham diagram so that FeO, Fe₂O₃, and Fe₃O₄ are reduced and Cr is oxidized. Specifically, a stainless steel is heat-treated in an atmosphere of H₂ and H₂O mixture (partial pressure ratio: H₂/H₂O=10/1 to 10⁴/1) at a temperature of 600 to 800° C. for several hours, thereby forming a chromia layer at its surface. If the treatment temperature is lower than 600° C., the production rate of the oxide at the surface is reduced, and accordingly the treatment takes a longer time; if the treatment temperature is excessively high, the stainless substrate may be undesirably sintered.

An alumina layer or a silica layer may be selectively formed at the surface of an Al- or Si-containing Fe-based alloy substrate in a similar process.

In the sol-gel method, it is believed that a M₁-O-M₂ bond (M₁: a metal ion in the metal oxide layer, M₂: a metal ion in the metal substrate) is formed between the metal substrate and the metal oxide layer by heating or firing to enhance the adhesion between the metal substrate and the metal oxide layer. The M₁-O-M₂ bond is easily formed when the hydroxy metal (-M₁OH and -M₂OH) content at the interface between the metal oxide layer and the metal substrate is high. The adhesion between the zeolite membrane and the metal oxide layer is probably ensured by a similar bond to the bond between the metal substrate and the metal oxide layer.

For the sol-gel method, the sol is prepared by adding water or an acid to an alkoxide solution in water or alcohol or a metal carboxylate. The alkoxide or the carboxylate is hydrolyzed and polycondensed into an alkoxide polymer or colloidal polymer containing a metal-oxygen-metal bond in sol. Examples of the alkoxide and carboxylate include, but not limited to, methoxides, etoxides, propoxides, butoxides, and carboxylates of Si, Al, Ti, Zr, Ba, Ge, Li, B, Nb, Pb, and other metals. The alkoxy groups bonding to these metals may be the same or different. The sol may be prepared from a single type of alkoxide or a mixture of alkoxides.

Alternatively, the sol may be prepared by a process in which a small amount of an acid is added to a precipitate of a metal hydroxide and subsequently the resulting colloidal solution is ripened, a process in which a metal oxide hydrate having a large surface area is produced and dispersed in water or a solution containing a small amount of an acid, or a process in which a solution of a metal salt is electrically deionized or electrolyzed.

The resulting sol is applied to the surface of the metal substrate by any method capable of uniformly coating the sol without particular limitation. Exemplary application methods include dipping in which the metal substrate is immersed in the solution, spin coating in which the solution is dripped onto the rotating substrate to form a liquid layer, spraying in which the solution is applied with a spray gun, laminar flow coating in which the solution is discharged upward from a solution delivery slot placed in the vicinity of the bottom surface of the substrate to form a narrow meniscus, and printing in which the solution is applied to the substrate through a screen.

After the application of the sol, the coating is dried and fired to form the metal oxide layer.

The resulting metal oxide layer preferably has a thickness between 1 nm and several tens of micrometers, and more preferably in the range of 1 nm to 10 μm, from the viewpoint of the uniformity and the peel resistance of the metal oxide layer.

The thickness of the metal oxide layer formed by the sol-gel method is set so as not to fill the pores of the metal substrate, and preferably between several nanometers and tens of thousands of nanometers (tens of micrometers). In the sol-gel method, a thickness of more than 10,000 nm (10 μm) is liable to cause the layer to crack and peel off, if the layer is formed by only one sequence of application. On the other hand, an excessively small thickness often results in a nonuniform layer, and the thickness is therefore at least 1 nm.

Although the metal oxide layer formed by the surface oxidation is harder to peel off than the layer formed by the sol-gel method, it is also preferable that the thickness of the surface-oxidized metal oxide layer be set between several nanometers and tens of thousands of nanometers (tens of micrometers) as in the sol-gel method. This is because an excessively large thickness is liable to cause the layer to peel off and a small thickness results in nonuniform layer.

Preferably, the metal oxide layer contains Si, which is a main constituent of zeolite, from the viewpoint of the adhesion to the zeolite.

The formation of the metal oxide layer can be confirmed by X-ray diffraction (XRD), energy dispersive analysis of X-rays (EDAX), transmission electron microscopy (TEM), diffractometry, and so on. In general, TEM is applied. Specifically, the thickness of the metal oxide layer can be determined by TEM observation of a section of a sample piece cut out by a gallium ion beam. For a relatively large thickness, scanning electron microscopy (SEM) or Auger electron spectroscopy is preferably adopted.

The sequence for forming the metal oxide layer may be repeated.

The zeolite membrane is synthesized (formed) on the support by any known method. For example, the membrane may be formed by hydrothermally treating a zeolite synthesis sol or gel on the support, or by immersing the support into a zeolite synthesis sol and subsequently performing hydrothermal treatment.

The starting material of the zeolite membrane contains a metal source for the zeolite skeleton, an alkali metal source, and water, and optionally a template or a crystallization accelerator.

Any metal source used in common zeolite synthesis can be used for the zeolite skeleton. Examples of such metal sources include silicon sources, such as silica colloid (sol), alkoxide silica, fumed silica, and water glass; and aluminium sources, such as aluminium nitrate and other aluminium salts, boehmite sol, silica-alumina complex colloid, aluminium hydroxide, aluminium oxide, and sodium aluminate. Other metals used for the skeleton include iron, chromium, yttrium, cerium, lanthanum, lithium, boron, gallium, phosphorus, beryllium, and titanium.

The alkali metal source is, for example, sodium hydroxide, potassium hydroxide, or the like. Examples of the template and crystallization accelerator include tetraalkylammonium compounds, such as tetramethylammonium salts, tetrapropylammonium salts, and tetrabutylammonium salts; and phosphonium compounds, such as tetrabutylphosphonium salts and benzyltriphenylphosphonium salts.

The crystal system of the zeolite is not particularly limited, and examples of the crystal system include zeolites A, X, Y, T, β, and ZSM-5, silicalite, and mordenite.

Since zeolite has pores with a uniform size depending on its type, a specific constituent can be separated from a mixture by the difference in molecular size, specifically, for example, by passing the mixture through a zeolite membrane having a pore size larger than the molecular size of the specific constituent and smaller than the molecular size of the other constituents in the mixture.

Separation can be conducted by the difference in absorption by zeolite. For example, zeolite A membranes, which are hydrophilic, can be used for dehydration from alcohols. Zeolite X and zeolite Y membranes, which absorb more CO₂ than nonpolar CH₄ or N₂, can be used for separation of CO₂ and CH₄ or CO₂ and N₂.

The zeolite may have ion exchange sites, and the ion exchange sites have various types of cation without particular limitation. Examples of such cations include H⁺, Li⁺, Na⁺, K⁺, Rb⁺, Cs⁺, ca²⁺, Mg²⁺, Ba²⁺, Ag²⁺, Cu²⁺, Ni²⁺, and La ³⁺.

The thickness of the zeolite membrane on the surface of the support is preferably between about 0.1 μm (100 nm) and several tens of micrometers (tens of thousands of nanometers). Since the permeability coefficient of the zeolite membrane depends on the thickness, the thickness is preferably as small as possible. However, an excessively small thickness is liable to cause a defect in the membrane. The thickness of the zeolite membrane can be determined by observing with an electron microscope a section of a sample piece cut out by a gallium ion beam.

Hydrothermal treatment for synthesizing the zeolite is generally performed in a pressure vessel at a temperature between room temperature and about 400° C., often up to 250° C., for several hours to several weeks. The resulting zeolite is washed and dried, and the crystallization accelerator is optionally removed by firing or the like. Thus, a separation membrane is completed. The firing temperature is generally in the range of about 150 to 600° C.

The sequence for synthesizing the zeolite may be repeated. The synthesis of the zeolite can be confirmed by XRD, SEM, and so on.

A zeolite composite membrane of the present invention includes the zeolite membrane support of the present invention and a zeolite membrane including an external zeolite layer over the surface at and/or an internal zeolite layer in the pores at the metal oxide layer side of the support. This structure is realized by forming the zeolite membrane over the surface and/or in the pores at the metal oxide layer side of the support. Thus, the zeolite composite membrane has a satisfactorily formed zeolite membrane. The zeolite composite membrane has suitable features for various functional materials used for separation, such as separation filters, and membrane reactors.

If the zeolite membrane has the internal zeolite layer in the pores at the metal oxide layer side of the zeolite membrane support, the size of these pores is set smaller and the zeolite is synthesized so as to fill the smaller pores. Thus, the mechanical strength of the zeolite membrane is enhanced, the formation of the zeolite membrane is not affected by stress resulting from thermal history in the synthesis of the zeolite, and the resulting zeolite membrane does not have defects, such as cracks.

By forming the zeolite membrane in the pores, not only high-silica zeolite having a composition of SiO₂/Al₂O₃>10, but also other zeolite having a composition satisfying the relationship SiO₂/Al₂O₃≦10 (typically faujasite (zeolite X and zeolite Y) and zeolite A) results in a favorable membrane with reliability.

A thickness of the internal zeolite layer of less than 0.1 μm cannot lead to a zeolite membrane having a sufficient mechanical strength. On the other hand, a thickness of more than 200 μm undesirably leads to a separation membrane having a low permeation rate. Accordingly, the thickness of the internal zeolite layer in the pores is set preferably in the range of 0.1 to 200 μm, more preferably 1 to 100 μm, and still more preferably 5 to 50 μm.

The zeolite membrane or internal zeolite layer formed in the pores herein means a zeolite layer formed in such a manner that zeolite crystals fill the pores in the membrane support in the depth direction from the surface of the support. The thickness of the internal zeolite layer in the pores refers to the thickness of the zeolite layer formed in the membrane support, that is, the depth of the zeolite layer from the surface of the membrane support.

For example, FIG. 2 schematically shows a zeolite membrane composed of an external layer having a thickness of 0.1 to 10 μm over the surface of the support and an internal layer having a thickness of 0.1 to 200 μm in the pores in the surface of the support. In this figure, circles represent the metal constituting the support, and the other areas in the support represent the pores. The internal layer is formed in such a manner that the zeolite fills the pores in the region with a depth of 200 μm from the surface of the support. The external zeolite layer is formed to a thickness of 0.1 to 10 μm over the surface of the support. In other words, the support has a zeolite layer with a thickness of 0.1 to 10 μm outside and a zeolite layer with a thickness of 0.1 to 200 μm inside.

For forming the zeolite layer in the pores of the support, some processes have been proposed in which the pores are impregnated with a zeolite synthesis sol or gel. Alternatively, for example, zeolite powder serving as seed crystals may be allowed to be present in the pores of the support in advance, and the support is immersed in a raw material and subjected to hydrothermal synthesis. For placing the seed crystals in the pores, previously synthesized specific zeolite crystals are pulverize to powder having a grain size less than the pore size of the support, and the powder is dispersed in a liquid, such as water or an alcohol, to prepare a disperse liquid having a predetermined concentration. A tubular support is immersed in the disperse liquid. The inside of the tube is decompressed with a vacuum pump to introduce the seed crystals into the pores. Alternatively, the zeolite crystals may be rubbed on the surface of the support to force the crystals into the pores. The concentration of the disperse liquid is such that the disperse liquid maintains its liquid or slurry features. An excessively high concentration reduces the fluidity and makes it difficult to introduce the seed crystals into the pores. A disperse liquid having an excessively low concentration requires much time to placing a sufficient amount of seed crystals in the pores. Thus, it is important to adjust the disperse liquid to an appropriate concentration.

In the formation of the zeolite membrane, the thicknesses of the internal and the external zeolite layer can be adjusted by selecting the concentration of the raw material or synthesis time.

The zeolite composite membrane of the present invention does not particularly limit the composition of the zeolite. Specifically, low silica zeolite having a composition of SiO₂/Al₂O₃≦10 can be used as well as high silica zeolite having a composition of SiO₂/Al₂O₃>10. Since the present invention allows such a low silica zeolite to form a membrane, it is particularly advantageous for use of the low silica zeolite.

The low silica zeolite having a composition of SiO₂/Al₂O₃≦10 is selected from among zeolite X, zeolite Y, and zeolite A. Hence, the crystal system of the zeolite may be of zeolite X, zeolite Y, or zeolite A.

Although Japanese Unexamined Patent Application Publication Nos. 2003-210953 and 2004-66188 have disclosed methods for forming a zeolite membrane in pores, these methods are remarkably different from the present invention in that a membrane of a high silica zeolite, such as silicalite or a DDR type, is formed in an alumina support. A zeolite Y membrane has also been disclosed in Japanese Unexamined Patent Application Publication No. 10-36113, but the support used for this membrane is made of alumina and different from the support of the present invention. These alumina supports have some problems as described above: they are brittle and easily broken and are accordingly difficult to handle; no joining technique has been developed for modularizing or upsizing the zeolite membrane; and the alumina in the supports is leached into the material sol or gel to change the composition of the zeolite or the crystal system, or to negatively affect the formation of the zeolite membrane.

### EXAMPLES

The present invention will now be further described with reference to examples and comparative examples. The examples herein are not intended to limit the invention, and various changes and modifications in form and detail can be made without departing from the scope and spirit of the invention.

### Example 1

A porous stainless substrate was oxidized by heating at 800° C. for 10 hours in a stream of a gas mixture of H₂ and water vapor (H₂/H₂O=80:1 in volume) to prepare a zeolite membrane support. The resulting support was subjected to XRD and EDAX analyses. As a result, it was confirmed that a Cr₂O₃ layer was formed at the surface of the substrate. Hence, the zeolite membrane support comprises the porous stainless substrate being a metal substrate and the Cr₂O₃ layer being a metal oxide layer.

The zeolite membrane support was provided with a zeolite membrane at its surface in the following process.

The starting materials for the zeolite membrane were water glass, sodium aluminate, sodium hydroxide, and ion-exchanged water. These materials were compounded to prepare a sol for synthesizing a zeolite having a composition Al₂O₃:SiO₂:Na₂O:H₂O=1:19.2:17:975 in mole. The zeolite membrane support was immersed in the sol and heated in that state at 90° C. in an autoclave for 24 hours to perform hydrothermal synthesis. A zeolite membrane was thus formed by hydrothermal treatment under the conditions above.

The resulting membrane was rinsed with ion-exchanged water, further subjected to ultrasonic cleaning, and dried. The membrane was observed by SEM to confirm that a fine membrane was obtained without any defect. The result of EDAX analysis showed the SiO₂/Al₂O₃ molar ratio was 4. The result of XRD analysis showed that the zeolite was of a structure type of zeolite Y.

### Example 2

Starting materials tetraethyl silicate (TEOS), ethanol (EtOH), and 0.06 percent by weight nitric acid solution were compounded to prepare a sol having a composition TEOS:EtOH:H₂O=1:5:4 for forming a metal oxide layer by a sol-gel method. A porous stainless tube substrate was immersed in the sol, dried at 70° C., and then fired (heated) at 500° C. for 30 minutes. Thus, a metal oxide layer (silica layer) was formed at the surface of the substrate to prepare a zeolite membrane support. The resulting support was subjected to EDAX analysis. As a result, it was confirmed that a SiO₂ layer was formed at the surface of the substrate. Hence, the zeolite membrane support comprises the porous stainless tube substrate being a metal substrate and the SiO₂ layer being a metal oxide layer.

The zeolite membrane support was provided with a zeolite membrane at its surface in the same manner as in Example 1. The membrane was observed by SEM to confirm that a fine membrane was obtained without any defect. The result of EDAX analysis showed the SiO₂/Al₂O₃ molar ratio was 4. The result of XRD analysis showed that the zeolite was of a structure type of zeolite Y.

### Example 3

Starting materials aluminium tri-sec-butoxide (Al(O-sec-Bu)₃), isopropyl alcohol (IPA), ethyl acetoacetate (EAcAc), and 0.03 percent by weight hydrochloric acid solution were compounded to prepare a sol having a composition of Al(O-sec-Bu)₃:IPA:EAcAc:H₂O=1:10:1:2 for forming an metal oxide layer by a sol-gel method. A porous stainless tube substrate was immersed in the sol, dried at 70° C., and then fired (heated) at 500° C. for 30 minutes. Thus, a metal oxide layer was formed at the surface of the substrate to prepare a zeolite membrane support. The resulting support was subjected to EDAX analysis. As a result, it was confirmed that a Al₂O₃ layer was formed at the surface of the substrate. Hence, the zeolite membrane support comprises the porous stainless tube substrate being a metal substrate and the Al₂O₃ layer being a metal oxide layer.

The zeolite membrane support was provided with a zeolite membrane at its surface in the same manner as in Example 1. The membrane was observed by SEM to confirm that a fine membrane was obtained without any defect. The result of EDAX analysis showed the SiO₂/Al₂O₃ molar ratio was 4. The result of XRD analysis showed that the zeolite was of a structure type of zeolite Y.

### Example 4

Starting materials zirconium propoxide (Zr(O-n-Pr)₄), isopropyl alcohol (IPA), ethyl acetoacetate (EAcAc), and 0.03 percent by weight hydrochloric acid solution were compounded to prepare a sol having a composition of Zr(O-n-Pr)₄:IPA:EAcAc:H₂O=1:10:2:2 for forming an metal oxide layer by a sol-gel method. A porous stainless tube substrate was immersed in the sol, dried at 70° C., and then fired at 500° C. for 30 minutes. Thus, a metal oxide layer was formed at the surface of the substrate to prepare a zeolite membrane support. The resulting support was subjected to EDAX analysis. As a result, it was confirmed that a ZrO₂ layer was formed at the surface of the substrate. Hence, the zeolite membrane support comprises the porous stainless tube substrate being a metal substrate and the ZrO₂ layer being a metal oxide layer.

The zeolite membrane support was provided with a zeolite membrane at its surface in the same manner as in Example 1. The membrane was observed by SEM to confirm that a fine membrane was obtained without any defect. The result of EDAX analysis showed the SiO₂/Al₂O₃ molar ratio was 4. The result of XRD analysis showed that the zeolite was of a structure type of zeolite Y.

### Example 5

Starting materials titanium dibutoxy diacetylacetonate (NACEM Ti) and isopropyl alcohol (IPA) were compound at a ratio of NACEM Ti:IPA=1:2 to prepare a sol for forming a metal oxide layer by a sol-gel method. A porous stainless tube substrate was immersed in the sol, dried at 70° C., and then fired at 500° C. for 30 minutes. Thus, a metal oxide layer was formed at the surface of the substrate to prepare a zeolite membrane support. The resulting support was subjected to EDAX analysis. As a result, it was confirmed that a TiO₂ layer was formed at the surface of the substrate. Hence, the zeolite membrane support comprises the porous stainless tube substrate being a metal substrate and the TiO₂ layer being a metal oxide layer.

The zeolite membrane support was provided with a zeolite membrane at its surface in the same manner as in Example 1. The membrane was observed by SEM to confirm that a fine membrane was obtained without any defect. The result of EDAX analysis showed the SiO₂/Al₂O₃ molar ratio was 4. The result of XRD analysis showed that the zeolite was of a structure type of zeolite Y.

### Example 6

A zeolite membrane support was prepared in the same manner as in Example 1.

The zeolite membrane support was provided with a zeolite membrane at its surface in the following process.

The starting materials for the zeolite membrane were water glass, sodium aluminate, sodium hydroxide, and ion-exchanged water. These materials were compounded to prepare a sol for synthesizing a zeolite having a composition Al₂O₃:SiO₂:Na₂O:H₂O=1:12.8:17:975 in mole. The zeolite membrane support was immersed in the sol and heated in that state at 90° C. in an autoclave for 24 hours to perform hydrothermal synthesis. A zeolite membrane was thus formed by hydrothermal treatment.

The resulting membrane was rinsed with ion-exchanged water, further subjected to ultrasonic cleaning, and dried. The membrane was observed by SEM to confirm that a fine membrane was obtained without any defect. The result of EDAX analysis showed the SiO₂/Al₂O₃ molar ratio was 2.5. The result of XRD analysis showed that the zeolite was of a structure type of zeolite X.

### Example 7

A zeolite membrane support was prepared in the same manner as in Example 2. The zeolite membrane support was provided with a zeolite membrane in the same manner as in Example 6. The membrane was observed by SEM to confirm that a fine membrane was obtained without any defect. The result of EDAX analysis showed the SiO₂/Al₂O₃ molar ratio was 2.5. The result of XRD analysis showed that the zeolite was of a structure type of zeolite X.

### Example 8

A zeolite membrane support was prepared in the same manner as in Example 3. The zeolite membrane support was provided with a zeolite membrane in the same manner as in Example 6. The membrane was observed by SEM to confirm that a fine membrane was obtained without any defect. The result of EDAX analysis showed the SiO₂/Al₂O₃ molar ratio was 2.5. The result of XRD analysis showed that the zeolite was of a structure type of zeolite X.

### Example 9

A zeolite membrane support was prepared in the same manner as in Example 4. The zeolite membrane support was provided with a zeolite membrane in the same manner as in Example 6. The membrane was observed by SEM to confirm that a fine membrane was obtained without any defect. The result of EDAX analysis showed the SiO₂/Al₂O₃ molar ratio was 2.5. The result of XRD analysis showed that the zeolite was of a structure type of zeolite X.

### Example 10

A zeolite membrane support was prepared in the same manner as in Example 5. The zeolite membrane support was provided with a zeolite membrane in the same manner as in Example 6. The membrane was observed by SEM to confirm that a fine membrane was obtained without any defect. The result of EDAX analysis showed the SiO₂/Al₂O₃ molar ratio was 2.5. The result of XRD analysis showed that the zeolite was of a structure type of zeolite X.

### Example 11

A zeolite membrane support was prepared in the same manner as in Example 1.

The zeolite membrane support was provided with a zeolite membrane at its surface in the following process.

The starting materials for the zeolite membrane were sodium silicate, aluminium hydroxide, sodium hydroxide, and ion-exchanged water. These materials were compounded to prepare a sol for synthesizing a zeolite having a composition Al₂O₃:SiO₂:Na₂O:H₂O=1:2:2:120 in mole. Seed crystals were applied to the above-prepared zeolite membrane support, then the support immersed in the sol was placed in an autoclave, and thus hydrothermal synthesis was performed by heating at 100° C. for 3.5 hours. A zeolite membrane was thus formed by hydrothermal treatment.

The resulting membrane was rinsed with ion-exchanged water, further subjected to ultrasonic cleaning, and dried. The membrane was observed by SEM to confirm that a fine membrane was obtained without any defect. The result of XRD analysis showed that the zeolite was of a structure type of zeolite A.

### Example 12

A zeolite membrane support was prepared in the same manner as in Example 2. The zeolite membrane support was provided with a zeolite membrane in the same manner as in Example 11. The membrane was observed by SEM to confirm that a fine membrane was obtained without any defect. The result of XRD analysis showed that the zeolite was of a structure type of zeolite A.

### Example 13

A zeolite membrane support was prepared in the same manner as in Example 3. The zeolite membrane support was provided with a zeolite membrane in the same manner as in Example 11. The membrane was observed by SEM to confirm that a fine membrane was obtained without any defect. The result of XRD analysis showed that the zeolite was of a structure type of zeolite A.

### Example 14

A zeolite membrane support was prepared in the same manner as in Example 4. The zeolite membrane support was provided with a zeolite membrane in the same manner as in Example 11. The membrane was observed by SEM to confirm that a fine membrane was obtained without any defect. The result of XRD analysis showed that the zeolite was of a structure type of zeolite A.

### Example 15

A zeolite membrane support was prepared in the same manner as in Example 5. The zeolite membrane support was provided with a zeolite membrane in the same manner as in Example 11. The membrane was observed by SEM to confirm that a fine membrane was obtained without any defect. The result of XRD analysis showed that the zeolite was of a structure type of zeolite A.

### Example 16

A zeolite membrane support was prepared in the same manner as in Example 1.

The zeolite membrane support was provided with a zeolite membrane at its surface in the following process.

The starting materials for the zeolite membrane were tetraethyl silicate (TEOS), tetrapropylammonium hydroxide (TPAOH), sodium hydroxide, and ion-exchanged water. These materials were compounded to prepare a sol for synthesizing a zeolite having a composition SiO₂:TPAOH:NaOH:H₂O=1:0.3:0.3:120 in mole. The zeolite membrane support was immersed in the sol and heated in that state at 180° C. in an autoclave for 24 hours to perform hydrothermal synthesis. A zeolite membrane was thus formed by hydrothermal treatment.

The resulting membrane was rinsed with ion-exchanged water, further subjected to ultrasonic cleaning, dried, and then fired at 500° C. for 6 hours to remove the TPAOH in the zeolite crystals. The membrane was observed by SEM to confirm that a fine membrane was obtained without any defect. The result of XRD analysis showed that the zeolite was a ZSM-5 silicalite.

### Example 17

A zeolite membrane support was prepared in the same manner as in Example 2. The zeolite membrane support was provided with a zeolite membrane in the same manner as in Example 16. The membrane was observed by SEM to confirm that a fine membrane was obtained without any defect. The result of XRD analysis showed that the zeolite was a ZSM-5 silicalite.

### Example 18

A zeolite membrane support was prepared in the same manner as in Example 3. The zeolite membrane support was provided with a zeolite membrane in the same manner as in Example 16. The membrane was observed by SEM to confirm that a fine membrane was obtained without any defect. The result of XRD analysis showed that the zeolite was a ZSM-5 silicalite.

### Example 19

A zeolite membrane support was prepared in the same manner as in Example 4. The zeolite membrane support was provided with a zeolite membrane in the same manner as in Example 16. The membrane was observed by SEM to confirm that a fine membrane was obtained without any defect. The result of XRD analysis showed that the zeolite was a ZSM-5 silicalite.

### Example 20

A zeolite membrane support was prepared in the same manner as in Example 5. The zeolite membrane support was provided with a zeolite membrane in the same manner as in Example 16. The membrane was observed by SEM to confirm that a fine membrane was obtained without any defect. The result of XRD analysis showed that the zeolite was a ZSM-5 silicalite.

### Comparative Example 1

A porous stainless tube substrate having no metal oxide layer by a sol-gel method or oxidation was used as the zeolite membrane support. The zeolite membrane support was provided with a zeolite membrane in the same manner as in Example 1. The resulting membrane was observed by SEM. As a result, although zeolite crystals were deposited on the surface of the support, the crystals do not cover the entire surface and the support was exposed. The result of EDAX analysis showed the SiO₂/Al₂O₃ molar ratio was 4. The result of XRD analysis showed that the zeolite was of a structure type of zeolite Y.

### Comparative Example 2

The same porous stainless tube substrate as in Comparative Example 1 was used as the zeolite membrane support, and a zeolite membrane was formed on the support in the same manner as in Example 6. The resulting membrane was observed by SEM. As a result, although zeolite crystals were deposited on the surface of the support, the crystals do not cover the entire surface and the support was exposed. The result of EDAX analysis showed the SiO₂/Al₂O₃ molar ratio was 2.5. The result of XRD analysis showed that the zeolite was of a structure type of zeolite X.

### Comparative Example 3

The same porous stainless tube substrate as in Comparative Example 1 was used as the zeolite membrane support, and a zeolite membrane was formed on the support in the same manner as in Example 11. The resulting membrane was observed by SEM. As a result, although zeolite crystals were deposited on the surface of the support, the crystals do not cover the entire surface and the support was exposed. The result of XRD analysis showed that the zeolite was of a structure type of zeolite A.

The examples above show that the zeolite membrane supports of the examples allow the formation of superior zeolite membranes at their surfaces, and Examples 1 to 15 show that zeolites (for example, zeolites Y, X, and A) other than high silica zeolites (for example silicalite zeolite as in Examples 16 to 20) can be satisfactorily deposited to form a membrane at the surface of the support.

### Example 21

A two-layer porous stainless tube substrate composed of an external layer having a pore size of 1 μm and an internal layer having a pore size of 3 μm was provided with an metal oxide layer (silica layer) in the same manner as in Example 2 to prepare a zeolite membrane support (two-layer tube).

Zeolite Y was pulverized with a mortar to powder having a grain size of less than 1 μm and disposed in water to prepare a 50 g/L zeolite-water slurry. The above-prepared zeolite membrane support or two-layer tube was immersed in the zeolite slurry with one opening of the tube closed. The inside pressure of the tube was reduced through the other opening with a vacuum pump to apply seed crystals to the support.

A zeolite membrane was formed on the zeolite membrane support in the same manner as in Example 1. The sequence of the formation of the zeolite membrane was repeated three times. Thus, a zeolite composite membrane (tube) was completed. The formation of the zeolite membrane was performed on the surface having the metal oxide layer. In other words, the zeolite membrane was formed on the external surface of the tube, but not on the internal surface. The result of XRD analysis showed that the zeolite was of a structure type of zeolite Y. The zeolite composite membrane was cut after a gas separation test, which will be described below, and the section of the membrane was observed and the result showed that the zeolite membrane includes a layer having a thickness of 10 μm over the surface of the support and a layer having a thickness of 20 μm in the pores.

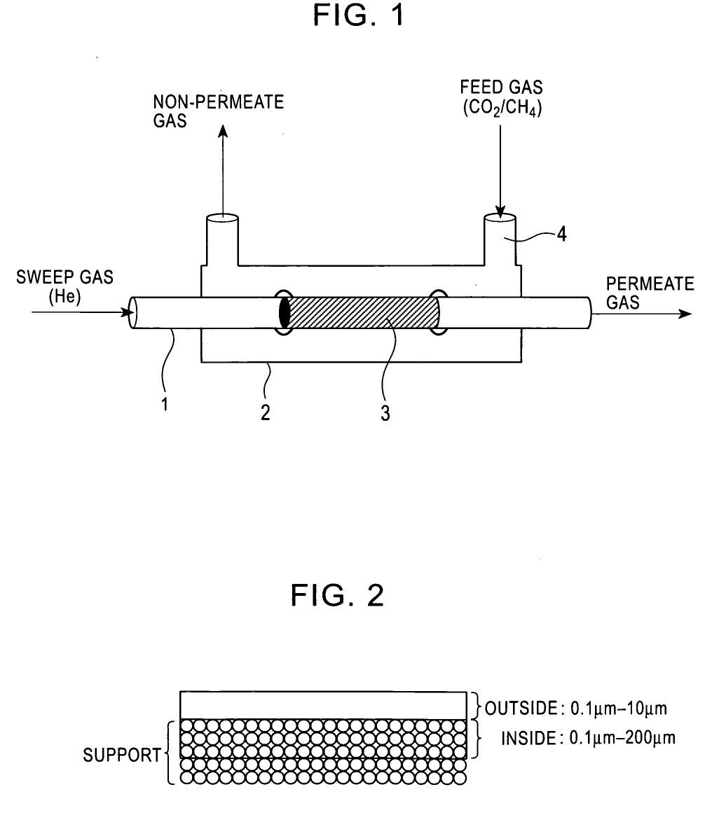

The resulting zeolite composite membrane tube was subjected to a gas separation test. The test was performed in the following process. FIG. 1 shows an arrangement for the gas separation test. The zeolite composite membrane tube (6 mm in outer diameter, 4 mm in inner diameter, 40 mm in length) 3 was placed in an inner tube 1 of a double tube structure, and a CH₄—CO₂ gas mixture was introduced into the space between the walls of the inner tube 1 and an outer tube 2 from a feed gas inlet 4 of the outer tube 2. The CH₄/CO₂ molar ratio in the gas mixture was 1/1, and the introduction speed was 200 mL/min. Helium (He) gas serving as a sweep gas was allowed to flow at a rate of 200 mL/min at 50° C. The permeate gas through the zeolite composite membrane 3 was subjected to gas chromatography and the gas separation factor α was determined from following equation (1):
α=(X_{CO2}/X_{CH4})/(Y_{CO2}/Y_{CH4}) (1)
wherein X_{CO2} and X_{CH4} respectively represent molar fractions of CO₂ and CH₄ in the permeate gas (helium or sweep gas was not taken into account), and Y_{CO2} and Y_{CH4} respectively represent molar fractions of CO₂ and CH₄ in the feed gas before permeation.

The obtained CO₂/CH₄ gas separation factor α was 1.8.

### Example 22

A zeolite membrane support (two-layer tube) was prepared in the same manner as in Example 21. Seed crystals were applied to the zeolite membrane support in the same manner as in Example 21 except that zeolite Y in its original state was rubbed on the support. Thus, a zeolite composite membrane tube was completed. The result of XRD analysis showed that the zeolite was of a structure type of zeolite Y. The zeolite composite membrane was cut after a gas separation test, which will be described later, and the section was observe and the result showed that the zeolite membrane includes a layer having a thickness of 10 μm over the surface of the support and a layer having a thickness of 30 μm in the pores.

The resulting zeolite composite membrane tube was subjected to the same gas separation test as in Example 21 and the gas separation factor α was obtained as in the same manner. The obtained CO₂/CH₄ gas separation factor α was 1.4.

The examples above show that the zeolite composite membrane of the present invention exhibits superior gas separation performance. This is attributed to the zeolite membrane favorably formed at the surface of the zeolite membrane support.

The zeolite membrane support of the present invention is suitably used as the supports of separation membranes, membrane reactors, and the like for molecular sieve gas separation, pervaporation, and other applications using the pores of the zeolite membrane. In particular, the support is advantageous for use of zeolite other than high silica zeolite.

1. A zeolite membrane support for supporting a zeolite membrane, the zeolite membrane support comprising: a metal substrate having a metal oxide layer at the surface thereof.

2. The zeolite membrane support according to claim 1, wherein the metal oxide layer has a thickness in the range of 1 nm to 10 μm.

3. The zeolite membrane support according to claim 1, wherein the metal substrate is porous.

4. The zeolite membrane support according to claim 3, wherein the metal substrate has a mean pore size in the range of 10 nm to 50 μm.

5. The zeolite membrane support according to claim 1, wherein the metal substrate comprises an iron-based metal.

6. The zeolite membrane support according to claim 1, wherein the metal oxide layer comprises an oxide selected from the group consisting of chromia, silica, and alumina.

7. A zeolite composite membrane comprising: the zeolite membrane support as set forth in claim 1 or 3; and a zeolite membrane comprising an external zeolite layer lying over the surface at and/or an internal zeolite layer lying in the pores at the metal oxide layer side of the zeolite membrane support.

8. The zeolite composite membrane according to claim 7, wherein the internal zeolite layer has a thickness in the range of 0.1 to 200 μm.

9. The zeolite composite membrane according to claim 7, wherein the zeolite membrane has a composition satisfying the relationship SiO₂/Al₂O₃≦10.

10. The zeolite composite membrane according to claim 9, wherein the zeolite membrane comprises a zeolite selected from the group consisting of zeolite X, zeolite Y, and zeolite A.
